(19) United States
(12) Patent Application Publication
(10) Pub. No.: US 2018/0067456 A1
(43) Pub. Date: Mar. 8, 2018

(54) HOLOGRAM DISPLAY DEVICE AND DISPLAY METHOD THEREOF

(71) Applicant: BOE Technology Group Co., Ltd., Beijing (CN)

(72) Inventors: Yuxin ZHANG, Beijing (CN); Yongda MA, Beijing (CN)

(21) Appl. No.: 15/691,802

(22) Filed: Aug. 31, 2017

(30) Foreign Application Priority Data
Sep. 5, 2016 (CN) 201610802255.9

(51) Int. Cl. G03H 1/26

(52) U.S. Cl. CPC G03H 1/268; G03H 2225/60; G03H 2223/19; G03H 2222/34; G03H 2222/13; G03H 2226/05

(57) ABSTRACT

The present disclosure provides a hologram display device and a display method thereof. The hologram display device includes an imaging unit including a plurality of imaging regions, wherein each imaging region forms a hologram image independently; a light source unit including a plurality of light sources arranged in an array, wherein each light source provides light to the imaging unit; an eye tracking unit that determines positions of both eyes of a viewer; and a controller that controls at least a part of the light sources and at least a part of the imaging regions to be turned on to perform hologram display according to the positions of both eyes of the viewer, so that light emitted from a turned-on light source passes through a turned-on imaging region and then irradiates towards the positions of both eyes of the viewer.

### CROSS-REFERENCE TO RELATED APPLICATIONS

The present application claims the priority of Chinese Patent Application No. 201610802255.9, filed on Sep. 5, 2016, the contents of which are incorporated herein in their entirety by reference.

### TECHNICAL FIELD

The present disclosure relates to the field of hologram display technology, and in particular, relates to a hologram display device and a display method thereof.

### BACKGROUND

A hologram display technology is a display technology to record and reproduce a real three-dimensional image of an object by using the principles of interference and diffraction of light. The hologram display technology can display all information on every aspect of the object, and is considered to be the final solution to achieve three-dimensional display.

It is well-known that, a hologram reproduction technology is different from a parallax stereoscopic display technology due to the hologram reproduction technology having advantages such as a large depth of field, causing no dizziness, and the like. However, the development of the hologram reproduction technology, especially of a video hologram reproduction technology, is subject to hardware constraints. This technology on one aspect requires a spatial light modulator to have a high resolution, and on another aspect requires a data processing system to finish a great amount of computation quickly. The conventional display technology of computer generated hologram may form a large wavefront viewing region. However, in the wavefront viewing region, except sub-regions corresponding to two viewing windows that allow light to enter the two pupils of a viewer, the rest of the wavefront viewing region cannot be viewed by the viewer and thus information thereof is wasted. In this regard, SeeReal Technologies S.A. has proposed to calculate only the hologram information that contributes to the two viewing windows for both eyes, that is, to reconstruct only the part of the wavefront viewing region that is directly viewed by the viewer. Thus, the viewer can see a fully reproduced holographic three-dimensional image by observing the viewing windows, thereby greatly reducing the amount of computed data. However, the existing hologram reproduction technology using the viewing window technology results in problems that a viewing angle is small, the viewer can observe only through the viewing windows in the order of diffraction, resulting in a limited viewing range, and it is not possible for multiple viewers to view a hologram image at the same time, etc.

### SUMMARY

To at least partially solve the problems of an existing hologram display device that a viewable range is small and it is not possible for multiple viewers to view a hologram image at the same time, the present disclosure provides a hologram display device and a display method thereof, which have a large viewable range and allow multiple viewers to view a hologram image at the same time.

Some embodiments of the present disclosure provide a hologram display device, including

an imaging unit including a plurality of imaging regions, wherein each imaging region is configured to form a hologram image independently;

a light source unit including a plurality of light sources arranged in an array, wherein each light source is configured to provide light to the imaging unit;

an eye tracking unit configured to determine positions of both eyes of a viewer; and

a controller configured to control at least a part of the light sources and at least a part of the imaging regions to be turned on to perform hologram display according to the positions of both eyes of the viewer, so that light emitted from a turned-on light source passes through a turned-on imaging region and then irradiates towards the positions of both eyes of the viewer.

In an embodiment, the imaging unit is a spatial light modulator including the plurality of imaging regions.

In an embodiment, the imaging unit includes a plurality of spatial light modulators, each of which serving as one of the imaging regions.

In an embodiment, the spatial light modulator is a liquid crystal display spatial light modulator.

In an embodiment, the hologram display device further includes a first adjustment unit provided between the light source unit and the imaging unit and configured to expand and collimate light emitted from the light source unit.

In an embodiment, the first adjustment unit includes a plurality of expansion collimator lens sets.

In an embodiment, each of the plurality of expansion collimator lens sets includes one large lens and one small lens having a smaller size than that of the large lens, a focal point of the large lens positioned proximal to the small lens overlaps a focal point of the small lens positioned proximal to the large lens.

In an embodiment, the hologram display device further includes a second adjustment unit provided at a light emergent side of the imaging unit and configured to converge light emitted through the imaging unit..

In an embodiment, the second adjustment unit includes a plurality of liquid crystal lenses and/or a plurality of optical convex lenses.

In an embodiment, the eye tracking unit includes any one of a camera, an eye tracker, and an infrared sensor.

In an embodiment, the light source unit includes light sources having a plurality of different colors.

In an embodiment, each of the plurality of light sources is a light emitting diode or a laser source.

Some embodiments of the present disclosure provide a display method of the hologram display device as described above. The display method includes steps of

determining positions of both eyes of a viewer by the eye tracking unit; and

controlling, by the controller, at least a part of the light sources and at least a part of the imaging regions to be turned on to perform hologram display according to the positions of both eyes of the viewer, so that light emitted from a turned-on light source passes through a turned-on imaging region and then irradiates towards the positions of both eyes of the viewer.

In the hologram display device provided by the embodiments of the present disclosure, the imaging unit includes the plurality of imaging regions, and the light source unit is in a form of an array. Light emitted from light sources at different positions in the array of the light source unit may irradiate towards different positions (i.e., may form hologram images at different positions, respectively) after passing through a same imaging region. Thus, a viewer is allowed to continuously view a hologram image in a large range while he/she moves, as long as positions of both eyes of the viewer are tracked by the eye tracking unit and light sources and imaging regions corresponding to the positions of the eyes are controlled to perform hologram display. In this way, a viewable range of a hologram image is increased, and multiple viewers are allowed to view hologram images at the same time, that is, different viewers view hologram images formed by different imaging regions and different light sources corresponding to the eye positions of the viewers, respectively.

### BRIEF DESCRIPTION OF THE DRAWINGS

FIG. 1 is a schematic side view showing a structure and a display state of a hologram display device according to an embodiment of the present disclosure;

FIG. 2 is a schematic side view showing another display state of the hologram display device shown in FIG. 1;

FIG. 3 is a schematic side view showing still another display state of the hologram display device shown in FIG. 1;

FIG. 4 is a schematic side view showing a structure of another hologram display device according to an embodiment of the present disclosure;

FIG. 5 is a schematic diagram showing a structure of one expansion collimator lens set employed in a hologram display device according to an embodiment of the present disclosure;

FIG. 6 is a schematic diagram showing several arrangement manners in which light sources of different colors are arranged in a multi-color light source array in a hologram display device according to an embodiment of the present disclosure;

FIG. 7 is a schematic diagram showing a division manner in which a spatial light modulator is divided into a plurality of imaging regions in a hologram display device according to an embodiment of the present disclosure; and

FIG. 8 is a schematic diagram showing another division manner in which a spatial light modulator is divided into a plurality of imaging regions in a hologram display device according to an embodiment of the present disclosure.

### DETAILED DESCRIPTION

To make one of ordinary skill in the art better understand the technical solutions according to the present disclosure, the present disclosure will be further described in detail below with reference to the accompanying drawings and embodiments..

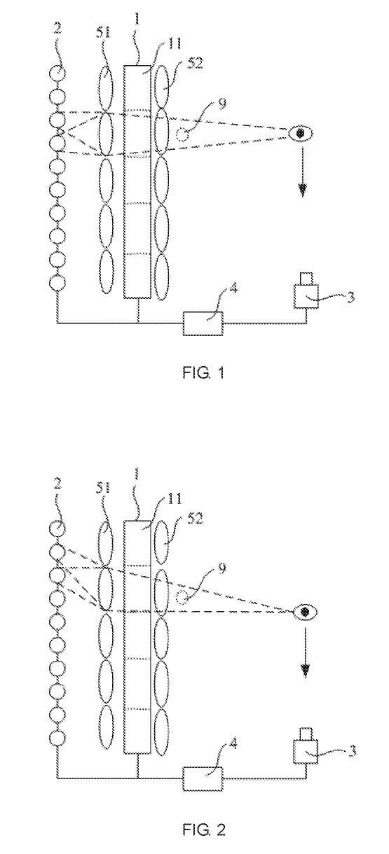

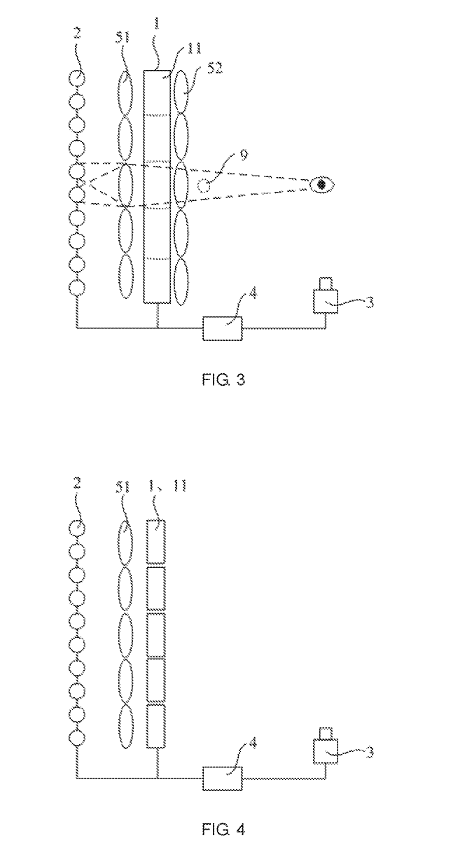

Some embodiments of the present disclosure provide a hologram display device, as shown in FIGS. 1 to 8. The hologram display device provided by the embodiments includes:

an imaging unit including a plurality of imaging regions 11, wherein each imaging region 11 is configured to form a hologram image 9 independently;

a light source unit including a plurality of light sources 2 arranged in an array, wherein each light source 2 is configured to provide light to the imaging unit;

an eye tracking unit 3 configured to determine positions of both eyes of a viewer (i.e. user); and

a controller 4 configured to control at least a part of the light sources 2 and at least a part of the imaging regions 11 to be turned on to perform hologram display according to the positions of both eyes of the viewer, so that light emitted from a turned-on light source 2 passes through a turned-on imaging region 11 and then irradiates towards the positions of both eyes of the viewer. It should be understood that, a data source for forming the hologram image 9 may be applied to at least the turned-on imaging regions 11 under the control of the controller 4. Further, the controller 4 may include a memory for storing the data source. Alternatively, the data source may be stored in an external storage device connected to the controller 4.

As shown in FIG. 1, in the hologram display device according to an embodiment, the light source unit includes a plurality of light sources 2 that emit light, and the plurality of light sources 2 are arranged in array, e.g., in a two-dimensional matrix. Each of FIGS. 1 to 4 shows a side view of the two-dimensional matrix in which the plurality of light sources 2 are arranged.

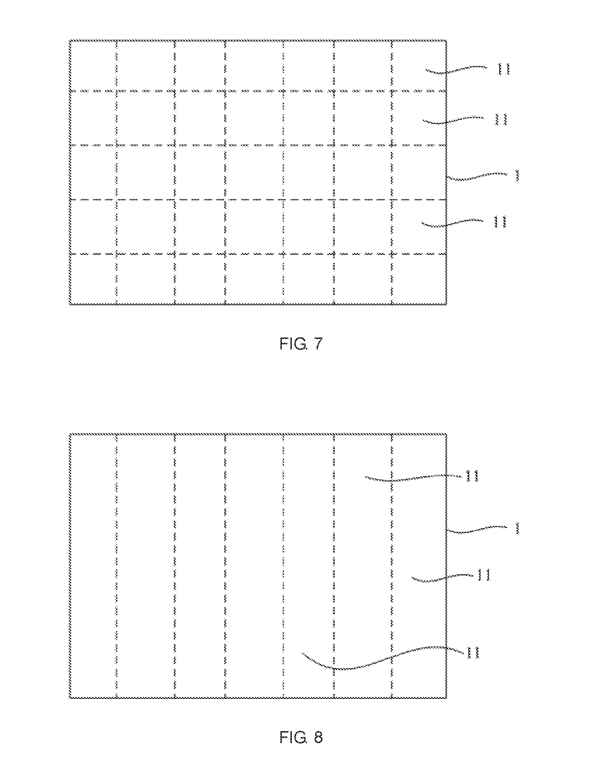

Correspondingly, the imaging unit is provided at a light emergent side of the light source unit, and can form the hologram image 9 by using the light emitted from the light source unit. The imaging unit according to the present embodiment includes the plurality of imaging regions 11, and each of the imaging regions 11 can form the hologram image 9 independently. In the embodiments of the present disclosure, a division manner in which the imaging unit is divided into the plurality of imaging regions 11 may be various. As shown in FIG. 7, the imaging unit may include a plurality of blocks in the form of a grid, and each of the blocks may be one imaging region 11. Alternatively, as shown in FIG. 8, the imaging unit may include a plurality of strips parallel to each other, and each of the strips may be one imaging region 11.

Light emitted from light sources 2 at different positions in the array of the light source unit may irradiate towards different positions (i.e., may form hologram images 9 at different positions, respectively) after passing through a same imaging region 11. Thus, as shown in FIGS. 1 to 3, a viewer is allowed to continuously view the hologram images 9 in a large range while he/she moves, as long as positions of both eyes of the viewer are tracked by the eye tracking unit and light sources 2 and imaging regions 11 corresponding to the positions of the eyes are controlled to perform hologram display. In this way, a viewable range of the hologram images 9 is increased, and multiple viewers are allowed to view hologram images at the same time. In the case where multiple viewers view the hologram images 9, different viewers may view hologram images 9 formed by different imaging regions 11 and different light sources 2 corresponding to the eye positions of the viewers, respectively.

It is to be understood that “light sources 2 and imaging regions 11 corresponding to the positions of the eyes” refer to light sources 2 and imaging regions 11 that can form a hologram image 9 visible for a viewer whose eyes are at the said positions.

In an embodiment of the present disclosure, when a certain imaging region 11 is to form the hologram image 9 at a certain position, the imaging region 11 may use light emitted from only one light source 2, or may use light emitted from multiple light sources 2.

In an embodiment of the present disclosure, it is possible that light emitted from different light sources 2 may form the hologram image 9 at a same position after passing through different imaging regions 11, respectively. In this case, the light sources 2 and the imaging regions 11 that can provide a better display effect may be selected to form the hologram image 9 according to positions of both eyes of a viewer. Alternatively, light sources 2 and imaging regions 11 to form the hologram image 9 may be determined in another way, for example, the previously turned-on light sources 2 and the previously turned-on imaging regions 11 may be continuously used until they cannot form the hologram image 9 at a desired position.

As an implementation of the present embodiment, the imaging unit may optionally be a spatial light modulator 1 including the plurality of imaging regions 11.

That is, as shown in FIGS. 1 to 3, one spatial light modulator (SLM) 1 may be employed as a device to form the hologram image 9, and the spatial light modulator 1 includes a plurality of regions that can be controlled independently. Each of the plurality of regions can receive light emitted from each of the light sources 2 and form the hologram image 9 independently, i.e., each of the plurality of regions may be one imaging region 11. By taking such a spatial light modulator 1 as the imaging unit, the imaging regions 11 of the imaging unit can have no gap therebetween, can be connected to each other closely, and can have no dead space therein.

As another implementation of the present embodiment, the imaging unit may optionally include a plurality of spatial light modulators 1, and each of the plurality of spatial light modulators 1 may serve as one imaging region 11.

That is, as shown in FIG. 4, the imaging unit may be formed by combining a plurality of separate spatial light modulators 1 together, wherein each of the spatial light modulators 1 is one imaging region 11, and the plurality of separate spatial light modulators 1 are spliced together to form the imaging unit. In this way, the plurality of spatial light modulators 1 are independent from each other and thus can be controlled easily. Further, ranges of light emitted through the plurality of spatial light modulators 1 are easy to be distinguished from each other.

Further optionally, the spatial light modulator 1 may be a liquid crystal display spatial light modulator (LCD-SLM) 1.

Optionally, the hologram display device according to the present embodiment of the present disclosure may further include a first adjustment unit provided between the light source unit and the imaging unit and configured to expand and collimate light emitted from the light source unit.

Further optionally, the first adjustment unit may include a plurality of expansion collimator lens sets 51.

An imaging unit such as the spatial light modulator 1 or the like may adopt collimated light to realize hologram display, and the first adjustment unit may be provided for expanding and collimating the light emitted from the light source unit, as shown in FIGS. 1 to 4. In an embodiment of the present disclosure, the first adjustment unit may include a plurality of expansion collimator lens sets 51, and each of the plurality of expansion collimator lens sets 51 may include one large lens 51a and one small lens 51b having a smaller size (e.g., diameter) than that of the large lens 51a, as shown in FIG. 5. For example, in each of the plurality of expansion collimator lens sets 51, a focal point of the large lens 51a positioned proximal to the small lens 51b overlaps a focal point of the small lens 51b positioned proximal to the large lens 51a, thereby realizing the adjustment of light such as expanding and collimating. For example, each of the imaging regions 11 may correspond to one expansion collimator lens set 51, or plural adjacent imaging regions 11 may correspond to one expansion collimator lens set 51.

Optionally, the hologram display device may further include a second adjustment unit provided at a light emergent side of the imaging unit and configured to converge light emitted through the imaging unit.

Further optionally, the second adjustment unit may include a plurality of liquid crystal lenses 52 and/or a plurality of optical convex lenses.

That is, as shown in FIGS. 1 to 3, the second adjustment unit may be provided at the light emergent side of the imaging unit for adjusting light to improve the display effect. The second adjustment unit may optionally be liquid crystal lenses 52 or optical convex lenses for converging light. In an embodiment of the present disclosure, each of the imaging regions 11 may correspond to one liquid crystal lens 52 or one optical convex lens, or plural adjacent imaging regions 11 may correspond to one liquid crystal lens 52 or one optical convex lens.

Optionally, the first adjustment unit and/or the second adjustment unit may be omitted. For example, the second adjustment unit is omitted from the hologram display device as shown in FIG. 4.

Optionally, the light source unit may include light sources having a plurality of different colors.

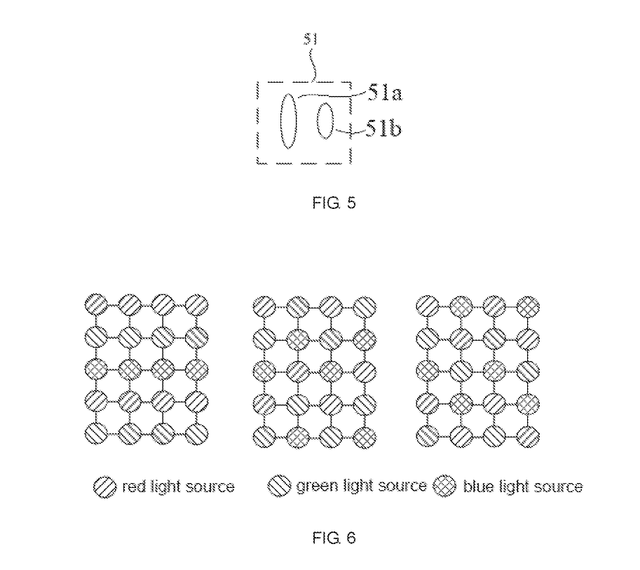

That is, the light sources 2 in the array of the light source unit may include light sources having a plurality of different colors such as red, green, and blue, and thus the hologram display device can realize color display. For example, as shown in FIG. 6, a specific arrangement manner in which the light sources 2 having different colors are arranged in an array may be various. For example, FIG. 6 shows three examples in which the light sources 2 having different colors are arranged in an array in different manners. A specific arrangement manner in which the light sources 2 having different colors are arranged in an array may be set as desired, and detailed description thereof is omitted herein.

Optionally, each of the plurality of light sources 2 may be a light emitting diode or a laser source.

That is, a light emitting diode (LED) or a laser source may be taken as each of the light sources 2 in a specific application. It should be noted that, the light sources 2 are not limited to light sources having a plurality of different colors, and the light sources 2 in the form of a light emitting diode or a laser source may be of a single color.

Optionally, the eye tracking unit 3 may include any one of a camera, an eye tracker, and an infrared sensor. The camera can collect an image of a viewer, and analyze the image to recognize both eyes of the viewer therein and determine positions of both eyes of the viewer. The eye tracker can track positions of both eyes of a viewer directly. The infrared sensor can determine positions of both eyes of a viewer according to the infrared light emitted from both eyes of the viewer. The eye tracking unit 3 can send the obtained positions of both eyes of a viewer to the controller 4.

The controller 4 can control at least a part of the light sources 2 and at least a part of the imaging regions 11 to be turned on to perform hologram display according to the positions of both eyes of the viewer. That is, the controller 4 can control at least a part of the imaging regions 11 and the corresponding light sources 2 to be turned on, so that light emitted from each of the turned-on light sources 2 passes through a turned-on imaging region 11 and then irradiates towards the positions of both eyes of the viewer, thereby allowing the viewer to see the hologram image 9 at different positions. In this way, a viewable range of the hologram image 9 is increased, and multiple viewers are allowed to view hologram images at the same time.

Some embodiments of the present disclosure further provide a display method of a hologram display device, wherein the hologram display device is the hologram display device as described above. The display method may specifically include steps of

determining positions of both eyes of a viewer by the eye tracking unit; and

controlling, by the controller, at least a part of the light sources and at least a part of the imaging regions to be turned on to perform hologram display according to the determined positions of both eyes of the viewer, so that light emitted from each of the turned-on light sources passes through a turned-on imaging region and then irradiates towards the determined positions of both eyes of the viewer.

That is, when hologram display is performed by using the hologram display device, positions of both eyes of a viewer may be continuously determined by using the eye tracking unit, and at least a part of the light sources and the corresponding imaging regions may be selected to be turned on to perform hologram display according to current positions of both eyes of the viewer, so that light emitted from each of the turned-on light sources passes through a turned-on imaging region and then irradiates towards the current positions of both eyes of the viewer, thereby ensuring the viewer can see the hologram image while the viewer moves.

Optionally, in the case where there exist plural viewers, the eye tracking unit can track positions of both eyes of each of the plural viewers, and plural imaging regions and the corresponding light sources are turned on, so that light emitted from the currently turned-on light sources passes through the currently turned-on imaging regions and then irradiates towards the positions of left and right eyes of the plural viewer, thereby realizing the effect that the plural viewers can see hologram images at the same time.

It should be understood that, the above embodiments are only exemplary embodiments for the purpose of explaining the principle of the present disclosure, and the present disclosure is not limited thereto. For one of ordinary skill in the art, various improvements and modifications may be made without departing from the spirit and essence of the present disclosure. These improvements and modifications also fall within the protection scope of the present disclosure.

What is claimed is:

1. A hologram display device, comprising
an imaging unit comprising a plurality of imaging regions, wherein each imaging region is configured to form a hologram image independently;
a light source unit comprising a plurality of light sources arranged in an array, wherein each light source is configured to provide light to the imaging unit;
an eye tracking unit configured to determine positions of both eyes of a viewer; and
a controller configured to control at least a part of the light sources and at least a part of the imaging regions to be turned on to perform hologram display according to the positions of both eyes of the viewer, so that light emitted from a turned-on light source passes through a turned-on imaging region and then irradiates towards the positions of both eyes of the viewer.

2. The hologram display device according to claim 1, wherein
the imaging unit is a spatial light modulator comprising the plurality of imaging regions.

3. The hologram display device according to claim 1, wherein
the imaging unit comprises a plurality of spatial light modulators,each of which serving as one of the imaging regions.

4. The hologram display device according to claim 2, wherein
the spatial light modulator is a liquid crystal display spatial light modulator.

5. The hologram display device according to claim 3, wherein
the spatial light modulator is a liquid crystal display spatial light modulator.

6. The hologram display device according to claim 1, further comprising
a first adjustment unit provided between the light source unit and the imaging unit and configured to expand and collimate light emitted from the light source unit.

7. The hologram display device according to claim 6, wherein
the first adjustment unit comprises a plurality of expansion collimator lens sets.

8. The hologram display device according to claim 7, wherein
each of the plurality of expansion collimator lens sets comprises one large lens and one small lens having a smaller size than that of the large lens, a focal point of the large lens positioned proximal to the small lens overlaps a focal point of the small lens positioned proximal to the large lens.

9. The hologram display device according to claim 1, further comprising
a second adjustment unit provided at a light emergent side of the imaging unit and configured to converge light emitted through the imaging unit.

10. The hologram display device according to claim 9, wherein
the second adjustment unit comprises a plurality of liquid crystal lenses and/or a plurality of optical convex lenses.

11. The hologram display device according to claim 1, wherein
the eye tracking unit comprises any one of a camera, an eye tracker, and an infrared sensor.

12. The hologram display device according to claim 1, wherein
the light source unit comprises light sources having a plurality of different colors.

13. The hologram display device according to claim 1, wherein
each of the plurality of light sources is a light emitting diode or a laser source.

14. A display method of the hologram display device according to claim 1, comprising steps of
determining positions of both eyes of a viewer by the eye tracking unit; and
controlling, by the controller, at least a part of the light sources and at least a part of the imaging regions to be turned on to perform hologram display according to the positions of both eyes of the viewer, so that light emitted from a turned-on light source passes through a turned-on imaging region and then irradiates towards the positions of both eyes of the viewer.
